(19) United States
(12) Patent Application Publication
(10) Pub. No.: US 2015/0229738 A1
(43) Pub. Date: Aug. 13, 2015

(54) METHOD FOR PROVIDING NETWORK SERVICE AND NETWORK SERVICE SERVER

(71) Applicant: AVer Information Inc., New Taipei City (TW)

(72) Inventors: Ping-Chen SU, New Taipei City (TW); Huah TU, New Taipei City (TW); Wei-Ting PONG, New Taipei City (TW); Guan-Jie HUANG, New Taipei City (TW)

(73) Assignee: AVer Information Inc., New Taipei City (TW)

(21) Appl. No.: 14/179,571

(22) Filed: Feb. 13, 2014

(51) Int. Cl. H04L 29/06; H04L 29/08

(52) U.S. Cl. CPC H04L 67/42; H04L 67/10

(57) ABSTRACT

In a method for providing a network service, a registration signal for waiting is received from a second client device through the network service server when a first client device is utilizing a network service provided by a network service server. Information about the second client device is registered on a waiting list through the network service server. A connection signal is received from a third client device through the network service server when the first client device is disconnected from the network service server. The connection signal from the third client device is utilized for the third client device to request the network service provided by the network service server. The network service is provided to the third client device through the network service server when the information about the third client device is on the waiting list. The present invention also discloses a network service server.

### BACKGROUND

1. Field of Invention

The present invention relates to a method for providing a network service and a network service server. More particularly, the present invention relates to a method for providing a network service according to a waiting list and a network service server.

2. Description of Related Art

In a client-server model, servers have resources for providing services and make decisions whether or not to provide the resources to client devices. The servers in this model are responsible for management of the resource, and client devices have no privileges to distribute the resources of the servers.

In some situations, resources of the servers can only be provided to a limited number of client devices at the same time. However, the servers cannot determine the priority of requiring the resources from the client devices, and, as a result, the highly concentrated resources are unable to be assigned to the client device most in need.

Above all, there is a need to provide network services to client devices that are most in need.

### SUMMARY

According to one embodiment of this invention, a method for providing a network service according to a waiting list is disclosed. The method for providing a network service includes the following steps:

(a) A registration signal for waiting is received from a second client device through a network service server when a first client device is utilizing a network service provided by the network service server.

(b) Information about the second client device is registered on a waiting list through the network service server.

(c) A connection signal from a third client device is received through the network service server when the first client device is disconnected from the network service server. Wherein, the connection signal from the third client device is utilized for the third client device to request the network service provided by the network service server.

(d) Determine if information about the third client device is on the waiting list.

(e) The network service is provided to the third client device through the network service server when the information about the third client device is on the waiting list.

According to another embodiment of this invention, a network service server is provided. The network service server includes a network card, a storage unit and a processing unit. The processing unit is electrically connected with the network card and the storage unit. The network card builds a connection with a network. The storage unit stores several instructions and a waiting list. The instructions stored in the storage unit are operable to cause the processing unit to: drive the network card to receive a registration signal for waiting from a second client device through the network when a first client device is utilizing a network service provided through the network card; register information about the second client device on the waiting list stored in the storage unit; drive the network card to receive a connection signal from a third client device through the network when the first client device is disconnected from the network service server, wherein the connection signal from the third client device is utilized for the third client device to request the network service provided through the network card; determine if information about the third client device is on the waiting list stored in the storage unit; and drive the network card to provide the network service to the third client device through the network when the information about the third client device is on the waiting list.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a method for providing a network service according to one embodiment of this invention;

FIG. 2 illustrates an embodiment of a system applying the method for providing a network service;

FIG. 3 is a flow diagram about the second client device to try to connect to the network service server will be described according to one embodiment of this invention; and

FIG. 4 illustrates a block diagram of a network service server according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

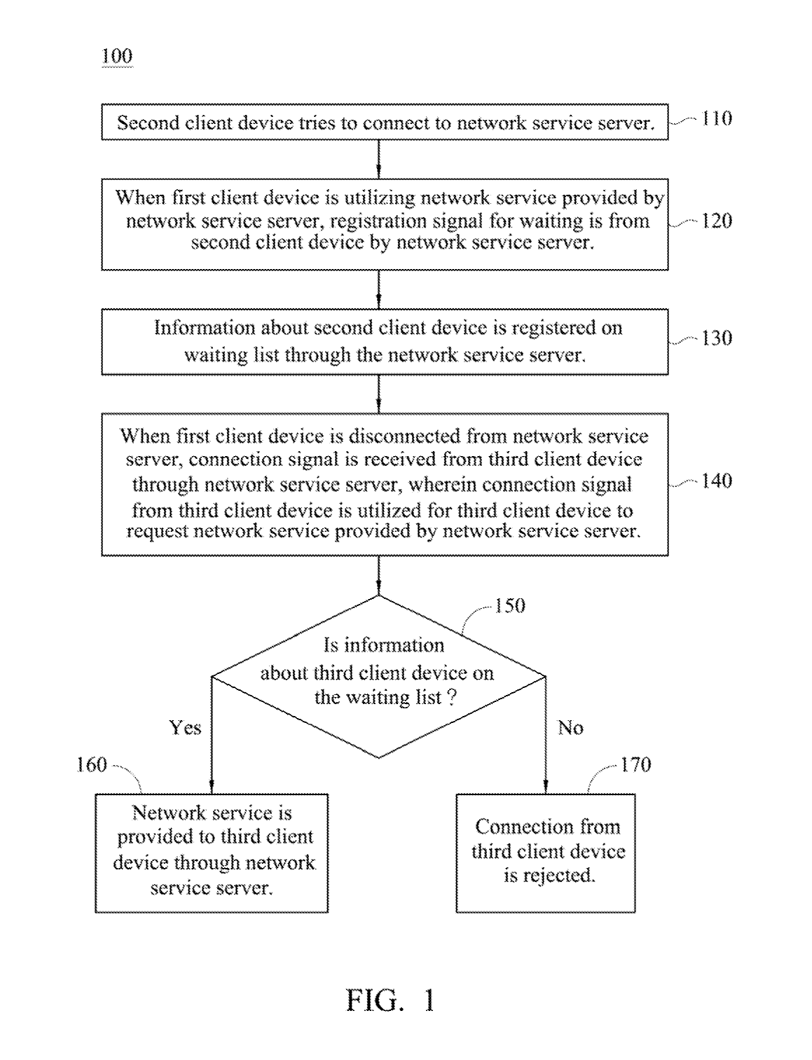

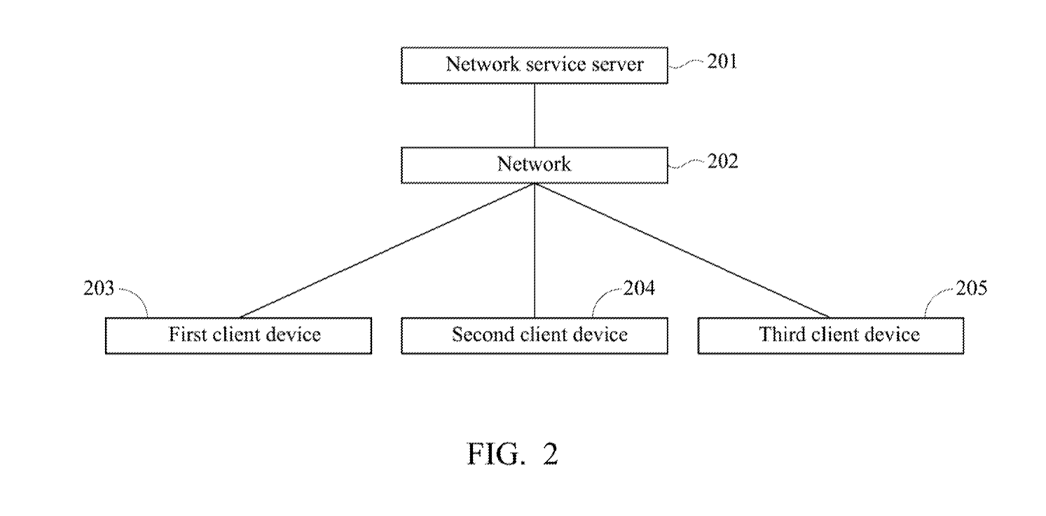

FIG. 1 is a flow diagram will be described that illustrates a method for providing a network service according to one embodiment of this invention. In the method for providing a network service, the network service is provided according to a waiting list. The method for providing a network service may take the form of a computer program product (for example, an APP) stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs); and solid-state disks (SSDs). FIG. 2 illustrates an embodiment of a system applying the method for providing a network service. Referring to both FIG. 1 and FIG. 2, the method 100 for providing a network service includes the following steps:

At step 120, a registration signal for waiting is received from a second client device 204 through a network service server 201 when a first client device 203 is utilizing a network service provided by the network service server 201 through the network 202. The network service server 201 may be a document camera or any other network service server applying a client-server model. The first client device 203 and the second client device 204 may be computers, smart phones or other electrical devices, which can connect to the network 202.

At step 130, information about the second client device 204 is registered on a waiting list through the network service server 201. Therefore, when another device is utilizing the network service, the information about the second client device 204 can be registered for being served latter. In one embodiment of this invention, when the network service server 201 is a document camera, the network service provided by the network service server 201 may be operations for controlling the network service server 201, such as zoom adjust, frame adjust or any other operation for controlling the network service server 201. Therefore, the network service being utilized by another device would not be interfered by the connection from the second client device 204. In some other embodiments of this invention, the network service provided by the network service server 201 is any other network service for a limited number of clients at the same time, which should not be limited by this disclosure. In some other embodiments of this invention, the network service server 201 may further provide other services for many clients at the same time (for example, providing images from the network service server 201 or any other network service for many clients at the same time), which can be provided without considering to the waiting list.

At step 140, a connection signal from a third client device 205 is received through the network service server 201 when the first client device 203 is disconnected from the network service server 201. Wherein, the connection signal from the third client device 205 is utilized for the third client device 205 to request the network service provided by the network service server 201. In other words, when the first client device 203 is disconnected from the network service server 201, the network service server 201 can keep receiving connection signals from other devices for providing the network service. Wherein, the third client device 205 may be the first client device 203 or the second client device 204. In addition, the third client device 205 may be the device other than the first client device 203 and the second client device 204.

At step 150, the network service server 201 determines if information about the third client device 205 is on the waiting list. In other words, with the determination at step 150, the network service server 201 can find out if the third client device 205 transmitted a registration signal for waiting to be registered on the waiting list previously.

At step 160, the network service is provided to the third client device 205 through the network service server 201 when the information about the third client device 205 is on the waiting list. Therefore, the third client device 205 being registered on the waiting list can obtain the network service with high priority once the device being served previously is disconnected from the network service server 201.

In addition, at step 170, the connection from the third client device 205 to the network service server 201 is rejected when the information about the third client device 205 is not on the waiting list.

In some embodiments of this invention, a disconnection signal can be received through an input unit before step 140 to trigger disconnecting the first client device 203 from the network service server 201. The input unit may be a keyboard, a mouse, a button, a graphical user interface (GUI) or any other type of input unit. In some embodiments of this invention, the input unit may be disposed on the network service server 201. In some other embodiments of this invention, the input unit may be disposed on a remote controller, and the remote controller and the network service server 201 are different devices. Hence, in some scenarios of this invention, a user of the third client device 205 being registered on the waiting list can operate the input unit to disconnect the device being served previously and immediately operate the third client device 205 to connect to the network service server 205, such that the third client device 503 can obtain the network service with high priority. Therefore, it can be guaranteed that the third client device 205 can be served immediately once the disconnection is performed. In addition, the network service provided by the network service server 201 may not be occupied after the disconnection is performed through the input unit, and such operation fits normal users' habits. Furthermore, even the user of the first client device 203, which was served previously, does not operate the first client device 203 to disconnect from the network service server 201, next user can still obtain the service by operating the input unit for disconnection.

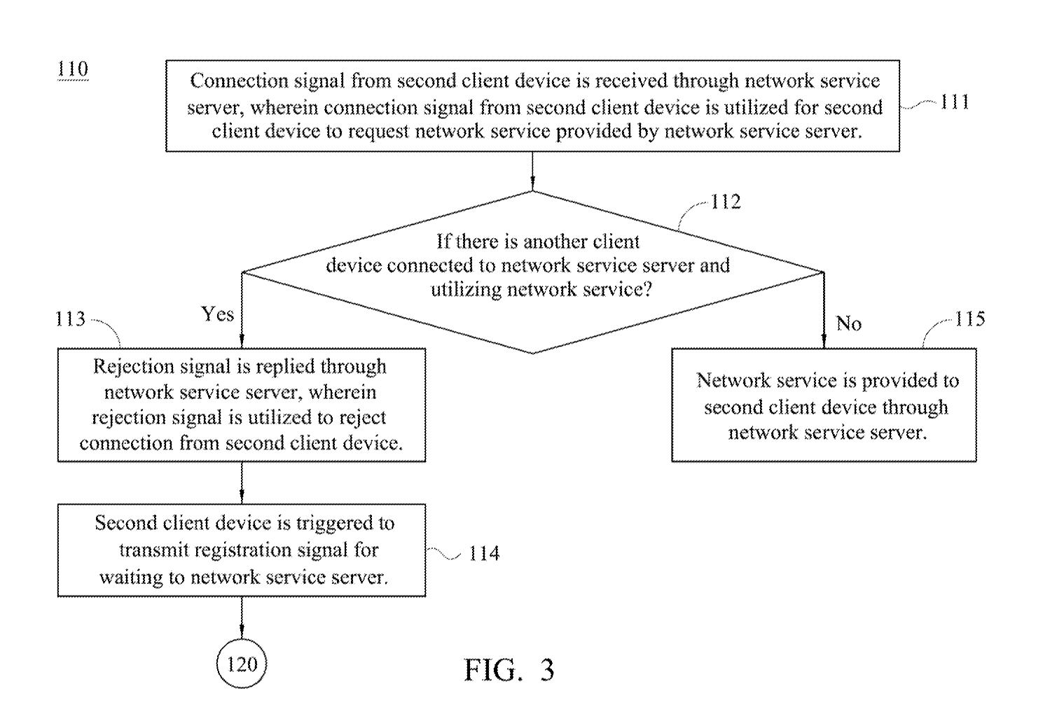

In some embodiments of this invention, the second client device 204 may try to connect to the network service server 201 (step 110) before the registration signal for waiting is received from the second client device 204 (step 120). Referring to FIG. 3, a flow diagram about the second client device 204 to try to connect to the network service server 201 (step 110) will be described according to one embodiment of this invention. The step for the second client device 204 to try to connect to the network service server 201 (step 110) may include the following steps:

At step 111, a connection signal from the second client device 204 is received through the network service server 201. The connection signal from the second client device 204 is utilized for the second client device 204 to request the network service provided by the network service server 201.

When the connection signal from the second client device 204 is received (step 111), the network service server 201 determines if there is another client device connected to the network service server 201 and utilizing the network service provided by the network service server 201 (step 112).

When there is another client device connected to the network service server 201 and utilizing the network service provided by the network service server 201, the network service server 201 replies a rejection signal to the second client device 204 through the network 202 (step 113). The rejection signal is utilized to reject a connection from the second client device 204. Therefore, collision caused by several devices requesting for the same network service, which can provide to a limited number of devices, at the same time can be avoided.

In addition, at step 114, when the second client device 204 receives the rejection signal, the second client device 204 is triggered to transmit the registration signal for waiting to the network service server 201, such that the registration signal for waiting can be received through the network service server 201 at step 120. Therefore, even if the connection from the second client device 204 is rejected, the second client device 204 can still register to the waiting list to wait for the network service provided by the network service server 201.

At step 115, when no device is connected to the network service server 201 and utilizing the network service provided by the network service server 201, the network service server can provide its network service to the second client device 204.

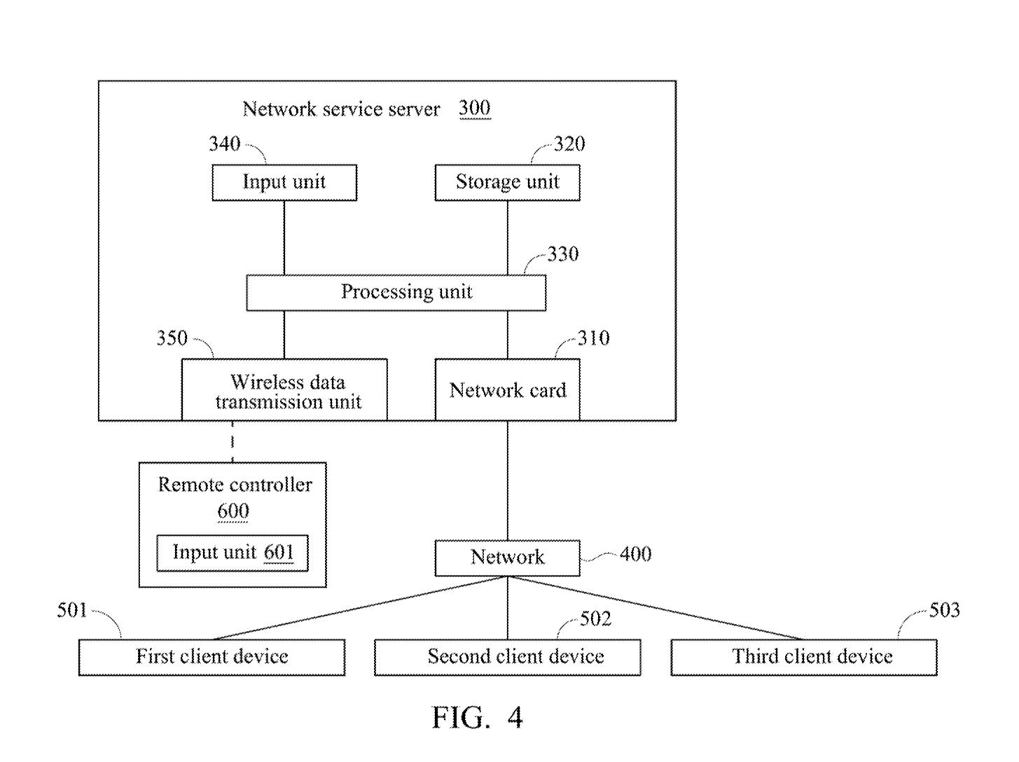

Referring to FIG. 4, a block diagram will be described that illustrates a network service server according to one embodiment of this invention. The network service server 300 includes a network card 310, a storage unit 320 and a processing unit 330. The processing unit 330 is electrically connected with the network card 310 and the storage unit 320.

The network card 310 builds a connection with a network 400 through a wired or wireless network communication protocol. The storage unit 320 may be a read only memory (ROM), a flash memory, a floppy disk, a hard disk drive (HDD), an optical storage device, a USB flash drive, a magnetic storage device, database accessed through a network or any other storage unit. The storage unit 320 stores many instructions operable to cause the processing unit 330 to provide functions of the network service server 300. The processing unit 330 may be a central processing unit (CPU), a control unit, a micro-processor or any other hardware for executing instructions.

The instructions stored in the storage unit 330 are operable to cause the processing unit 330 to execute the following steps: when a first client device 501 is utilizing a network service provided through the network card 310, the processing unit 330 drives the network card 330 to receive a registration signal for waiting from a second client device 502 through the network 400. The network service server 300 may be a document camera or any other network service server applying a client-server model. The first client device 501 and the second client device 502 may be computers, smart phones or other electrical devices, which can connect to the network 400. The second client device 502 may connect to the network 400 through a wired or wireless network communication protocol for transmitting the registration signal for waiting.

The processing unit 330 registers information about the second client device 502 on the waiting list stored in the storage unit 320. Therefore, when another device is utilizing the network service, the information about the second client device 502 can be registered for being served latter. In one embodiment of this invention, when the network service server 300 is a document camera, the network service provided by the network service server 300 may be operations for controlling the network service server 300, such as zoom adjust, frame adjust or any other operation for controlling the network service server 300. Therefore, the network service being utilized by another device would not be interfered by the connection from the second client device 300. In some other embodiments of this invention, the network service provided by the network service server 300 is any other network service for a limited number of clients at the same time, which should not be limited by this disclosure. In some other embodiments of this invention, the network service server 300 may further provide other services for many clients at the same time (for example, providing images from the network service server 300 or any other network service for many clients at the same time), which can be provided without considering to the waiting list.

When the first client device 501 is disconnected from the network service server 300, the processing unit 330 drives the network card 310 to receive a connection signal from a third client device 503 through the network 400. The connection signal from the third client device 503 is utilized for the third client device 503 to request the network service provided through the network card 310. In other words, when the first client device 501 is disconnected from the network service server 300, the network service server 300 can keep receiving connection signals from other devices for providing the network service. Wherein, the third client device 503 may be the first client device 501 or the second client device 502. In addition, the third client device 503 may be the device other than the first client device 501 and the second client device 502. The third client device 503 may connect to the network 400 through a wired or wireless network communication protocol to transmit the connection signal.

The processing unit 330 determines if information about the third client device 503 is on the waiting list stored in the storage unit.

When the information about the third client device 503 is on the waiting list, the processing unit 330 drives the network card 310 to provide the network service to the third client device 503 through the network 400. Therefore, the third client device 503 being registered on the waiting list can obtain the network service with high priority once the device being served previously is disconnected from the network service server 300.

In some embodiments of this invention, the network service server 300 may further include an input unit 340, which is electrically connected with the processing unit 330. The input unit 340 may be a keyboard, a mouse, a button, a graphical user interface (GUI) or any other type of input unit. Hence, when the processing unit 330 receives a disconnection signal through the input unit 340, the processing unit triggers disconnecting the first client device 501 from the network service server 300. In some scenarios of this invention, a user of the third client device 501 being registered on the waiting list can operate the input unit 340 of the network service server 300 to disconnect the device being served by the network service server 300 previously, and the user immediately operate the third client device 503 to connect to the network service server 300, such that the third client device 503 can obtain the network service with high priority. Therefore, it can be guaranteed that the third client device 503 can be served immediately once the disconnection is performed. In addition, the network service provided by the network service server 300 may not be occupied after the disconnection is performed through the input unit 340 of the network service server 300, and such operation fits normal users' habits.

In some other embodiments of this invention, the network service server 300 may further include a wireless data transmission unit 350, which is electrically connected with the processing unit 330. The wireless data transmission unit 350 may transmit/receive data through a wireless data transmission interface, such as Bluetooth interface, Infrared Data Association (IR/DA) protocol, IEEE 802.11 series, Wireless Fidelity (Wi-Fi) infrastructure, Zigbee etc. Hence, when the processing unit 330 receives a disconnection signal, which is generated by the input unit 601 of a remote controller 600, through the wireless data transmission unit 350, the processing unit 330 triggers disconnecting the first client device 501 from the network service server 300. In some scenarios of this invention, a user of the third client device 501 being registered on the waiting list can operate the input unit 601 of the remote controller 600 to disconnect the device being served by the network service server 300 previously, and the user immediately operate the third client device 503 to connect to the network service server 300, such that the third client device 503 can obtain the network service with high priority. Therefore, it can be guaranteed that the third client device 503 can be served immediately once the disconnection is performed. In addition, the network service provided by the network service server 300 may not be occupied after the disconnection is performed through the remote controller 600, and such operation fits normal users' habits.

In some embodiments of this invention, before the second client device 502 transmits the registration signal for waiting, the second client device 502 may try to connect to the network service server 300 to request for the network service. In detail, the processing unit 330 may drive the network card 310 to receive a connection signal from the second client device 502 through the network 400. The connection signal from the second client device 502 is utilized for the second client device 502 to request the network service. When the connection signal from the second client device 502 is received, the processing unit 330 may determine if there is another client device connected to the network service server 300 and utilizing the network service. When there is another client device connected to the network service server 300 and utilizing the network service, the processing unit drives the network card 310 to reply a rejection signal to the second client device 502 through the network 400. The rejection signal is utilized to reject a connection from the second client device 502. Therefore, collision is caused by several devices connected to the network service server 300 to request for the same network service, which can provide to a limited number of devices, at the same time can be avoided.

In addition, when the second client device 502 receives the rejection signal, the second client device 502 is triggered to transmit the registration signal for waiting to the network service server 300. Therefore, even if the connection from the second client device 502 is rejected, the second client device 502 can still register to the waiting list stored in the storage unit 320 to wait for the network service provided by the network service server 300.

When there is no device connected to the network service server 300 and utilizing the network service provided by the network service server 300, the processing unit 330 can drive the network card 310 to provide its network service to the second client device 502.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for providing a network service, comprising:
(a) receiving a registration signal for waiting from a second client device through a network service server when a first client device is utilizing a network service provided by the network service server;
(b) registering information about the second client device on a waiting list through the network service server;
(c) receiving a connection signal from a third client device through the network service server when the first client device is disconnected from the network service server, wherein the connection signal from the third client device is utilized for the third client device to request the network service provided by the network service server;
(d) determining if information about the third client device is on the waiting list; and
(e) providing the network service to the third client device through the network service server when the information about the third client device is on the waiting list.

2. The method for providing a network service of claim 1, further comprising:
receiving a connection signal from the second client device through the network service server, wherein the connection signal from the second client device is utilized for the second client device to request the network service provided by the network service server;
determining if there is another client device connected to the network service server and utilizing the network service provided by the network service server when the connection signal from the second client device is received; and
replying a rejection signal through the network service server when there is another client device connected to the network service server and utilizing the network service provided by the network service server, wherein the rejection signal is utilized to reject a connection from the second client device.

3. The method for providing a network service of claim 2, further comprising:
triggering the second client device to transmit the registration signal for waiting to the network service server when the second client device receives the rejection signal.

4. The method for providing a network service of claim 1, further comprising:
triggering disconnecting the first client device from the network service server when a disconnection signal is received through an input device.

5. The method for providing a network service of claim 4, wherein the input unit is disposed on the network service server.

6. The method for providing a network service of claim 4, wherein the input device is disposed on a remote controller, and the remote controller and the network service server are different devices.

7. A network service server, comprising:
a network card configured to build a connection with a network;
a storage unit configured to store a plurality of instructions and a waiting list; and
a processing unit electrically connected with the network card and the storage unit, wherein the instructions stored in the storage unit are operable to cause the processing unit to:
drive the network card to receive a registration signal for waiting from a second client device through the network when a first client device is utilizing a network service provided through the network card;
register information about the second client device on the waiting list stored in the storage unit;
drive the network card to receive a connection signal from a third client device through the network when the first client device is disconnected from the network service server, wherein the connection signal from the third client device is utilized for the third client device to request the network service provided through the network card;
determine if information about the third client device is on the waiting list stored in the storage unit; and
drive the network card to provide the network service to the third client device through the network when the information about the third client device is on the waiting list.

8. The network service server of claim 7, wherein the storage unit further stores instructions operable to cause the processing unit to:
drive the network card to receive a connection signal from the second client device through the network, wherein the connection signal from the second client device is utilized for the second client device to request the network service;
determine if there is another client device connected to the network service server and utilizing the network service provided by the network service server when the connection signal from the second client device is received; and
drive the network card to reply a rejection signal through the network when there is another client device connected to the network service server and utilizing the network service provided by the network service server, wherein the rejection signal is utilized to reject a connection from the second client device.

9. The network service server of claim 7, wherein the network service server further comprises an input unit, the input unit is electrically connected with the processing unit, and the storage unit further stores instructions operable to cause the processing unit to:
trigger disconnecting the first client device from the network service server when a disconnection signal is received through the input device.

10. The network service server of claim 7, wherein the network service server further comprises a wireless data transmission unit, the wireless data transmission unit is electrically connected with the processing unit, and the storage unit further stores instructions operable to cause the processing unit to:
trigger disconnecting the first client device from the network service server when a disconnection signal generated by an input unit of a remote controller is received through the wireless data transmission unit.
